(19) United States
(12) Patent Application Publication
(10) Pub. No.: US 2011/0286909 A1
(43) Pub. Date: Nov. 24, 2011

(54) Generation Of CO Using Off-Gas As Source

(75) Inventors: Sanjay Kakkar, Missouri City, TX (US); Tarun D. Vakil, Houston, TX (US)

(73) Assignee: Air Liquide Process & Construction, Inc., Houston, TX (US)

(21) Appl. No.: 12/784,929

(22) Filed: May 21, 2010

(51) Int. Cl. C01B 31/18

(52) U.S. Cl. 423/418.2

(57) ABSTRACT

A method for generating CO using an off-gas as a source is provided. This method includes providing an off-gas feed stream, wherein said off-gas feed stream comprises CO₂ and H₂. This method also includes introducing said off-gas feed stream into a reactor, thereby producing an intermediate gas stream comprising CO and H₂O. And this method includes separating said intermediate gas stream in a first separation device, thereby producing a product gas stream comprising CO.

### BACKGROUND

To produce CO, the process is to go through the process of producing syngas through conventional SMR or POX and then recovering CO from the syngas using cryogenic process to produce high purity CO stream. This process could be very energy intensive and cost to produce CO could be very high.

An alternate approach to produce CO would be to investigate the area for off gas streams from refineries or existing H2 plants where CO is required. These off-gas typically contain H2 (20-50% s), CO2 (30-40%) and even CO in some cases (10-15%). The gas is typically at a very low pressure 5-50 psig.

### SUMMARY

The present invention is a method for generating CO using an off-gas as a source. This method includes providing an off-gas feed stream, wherein said off-gas feed stream comprises CO₂ and H₂. This method also includes introducing said off-gas feed stream into a reactor, thereby producing an intermediate gas stream comprising CO and H₂O. And this method includes separating said intermediate gas stream in a first separation device, thereby producing a product gas stream comprising CO.

### BRIEF DESCRIPTION OF THE FIGURES

FIG. 1 is a schematic representation of one embodiment of the present invention.

### DESCRIPTION OF PREFERRED EMBODIMENTS

The new process would involve compressing this off gas to a suitable pressure and temperature which will facilitate the reverse water shift reaction as described below:

CO2+H2←--------→CO+H2O

The ratios of the reactants will have to be adjusted to move the reaction to produce CO.

The CO and other components can then be separated using Cryogenic technologies.

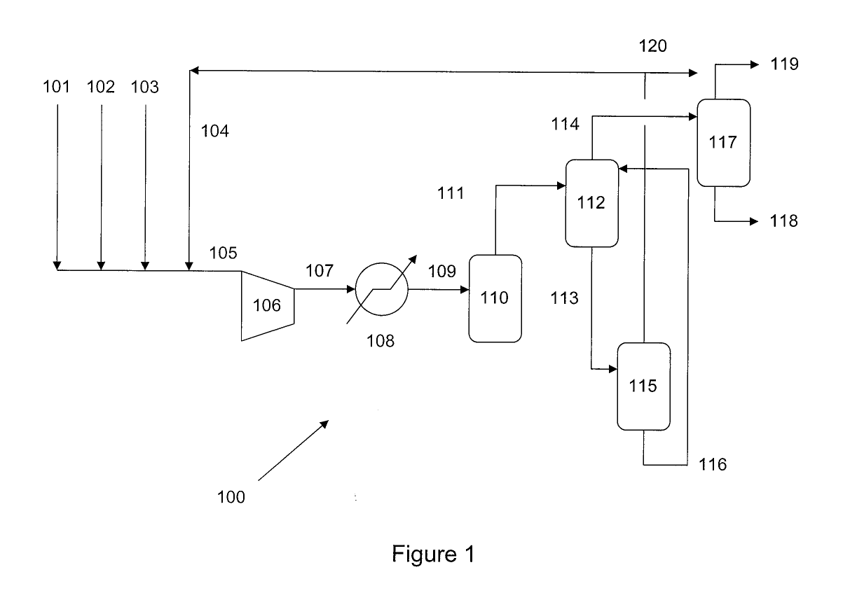

Turning now to FIG. 1 (the sole FIGURE), system 100 for the generation of CO using an off-gas as a source is disclosed. Off-gas streams 101, 102, 103, from a single source or potentially multiple sources, are combined with recycled top gas 104 (discussed below) to form off-gas feed stream 105.

These off-gas streams are typically at very low pressure, commonly between about 5 psig and about 50 psig. These off-gas streams may have a pressure of between about 10 psig and about 40 psig. These off-gas streams may have a pressure of between about 20 psig and about 30 psig. These off-gas streams 101, 102, 103 are not purposely generated in a Steam Methane Reformer, a Partial Oxidation Reformer, or an Autothermal Reformer, but are off-gas byproducts from upstream reactions.

The composition of these off-gas streams will vary according to the particular source, but typically will contain between about 10-50% hydrogen; between 30-40% carbon dioxide, and may contain between about 10-15% carbon monoxide. These off-gas streams may contain between about 20-40% hydrogen. These off-gas streams may also contain methane (possibly between 3-4%) and nitrogen (possibly between 1-4%)

Off-gas feed stream 105 may be introduced into compressor 106, thereby producing compressed off-gas stream 107. Compressed off-gas stream 107 may have a pressure of between about 300 psig and about 350 psig. Compressed off-gas stream 107 may then be heated in heat exchange device 108, thereby producing heated off-gas stream 109. Heated off-gas stream 109 may have a temperature between about 750 and about 950 F.

The off-gas stream (that may have been compressed or heated) is then introduced into reactor 110, thereby producing an intermediate gas stream 111. Intermediate gas stream 111 contains carbon monoxide. Reactor 110 may utilize a reverse water gas shift reaction.

Intermediate gas stream 111 may then be introduced to amine system 112, thereby producing carbon monoxide rich gas stream 114 and carbon dioxide rich gas stream 113. Carbon dioxide rich gas stream 113 may be introduced into a second separation device 115, thereby producing top gas stream 104 that is recycled ,120 stream which is byproduct carbon dioxide, and bottom stream 116. Bottom stream 116 may be recycled in to amine system 112.

Carbon monoxide rich gas stream 114 (or possibly intermediate gas stream 111, if amine system 112 is not utilized) is then introduced into first separation device 117, thereby producing by-product stream 118 and product gas stream 119. Product gas stream 119 is very rich in carbon monoxide, and is subsequently utilized downstream.

First separation device 117 may be a cryogenic separation means. First separation device 117 may be a cryogenic separation means, a membrane separation means, an adsorption separation means, or any other appropriate separation means known to the skilled artisan. The separation device also may be combination of the above processes.

What is claimed is:

1. A method for generating CO using an off-gas as a source, comprising:
i) providing an off-gas feed stream, wherein said off-gas feed stream comprises CO₂ and H₂;
ii) introducing said off-gas feed stream into a reactor, thereby producing an intermediate gas stream comprising CO and H₂O; and
iii) separating said intermediate gas stream in a first separation device, thereby producing a product gas stream comprising CO.

2. The method of claim 1, further comprising:
ia) compressing said off-gas feed stream in a compressor, thereby producing a compressed off-gas stream; and
ii) introducing said compressed off-gas stream into said reactor, thereby producing said intermediate gas stream comprising CO and H₂O.

3. The method of claim 2, further comprising:
ib) heating said compressed off-gas stream in a heat exchange device, thereby producing a heated off-gas stream; and
ii) introducing said heated off-gas stream into said reactor, thereby producing said intermediate gas stream comprising CO and H₂O.

4. The method of claim 1, further comprising:
iia) introducing said intermediate gas to an amine system, thereby producing a CO rich gas stream and a CO2 rich gas stream;
iib) introducing said CO2 rich gas stream to a second separation device, thereby producing a top gas stream and a bottom gas stream;
iic) recycling at least a portion of said top gas stream to combine with said off-gas stream;
iid) using the remaining top gas as a byproduct stream
iie) recycling said bottom gas stream to said amine system; and
iii) separating said CO rich gas stream in said first separation device, thereby producing said product gas stream comprising CO.

5. The method of claim 1, wherein said reactor comprises a reverse water gas shift reaction.

6. The method of claim 1, wherein said first separation device comprises a cryogenic separation means.

7. The method of claim 1, wherein said first separation device is selected from the group consisting of a cryogenic separation means, a membrane separation means, and an adsorption separation means.

8. The method of claim 1, wherein said off-gas feed stream comprises between about 10% and about 50% H₂.

9. The method of claim 8, wherein said off-gas feed stream comprises between about 20% and about 40% H₂.

10. The method of claim 1, wherein said off-gas feed stream comprises between about 30% and about 40% CO₂.

11. The method of claim 1, wherein said off-gas feed stream has a pressure of between about 5 psig and about 50 psig.

12. The method of claim 11, wherein said off-gas feed stream has a pressure of between about 10 psig and about 40 psig.

13. The method of claim 2, wherein said compressed off-gas stream has a pressure of between about 300 psig and about 350 psig.

14. The method of claim 3, wherein said heated off-gas stream has a temperature of between about 750 and about 950 F.

15. The method of claim 1, wherein said off-gas feed stream is not generated in a Steam Methane Reformer, a Partial Oxidation Reformer or an Autothermal Reformer.
